(19) United States
(12) Patent Application Publication
(10) Pub. No.: US 2014/0088226 A1
(43) Pub. Date: Mar. 27, 2014

(54) DIANHYDROHEXITOL DIESTERS OF 2-ETHYLHEPTANOIC ACID

(71) Applicants: Andreas Gevers, Bottrop (DE); Hinnerk Becker, Essen (DE); Michael Grass, Haltern am See (DE); Markus Winterberg, Datteln (DE); Dietrich Maschmeyer, Recklinghausen (DE); Christian Boeing, Koeln (DE)

(72) Inventors: Andreas Gevers, Bottrop (DE); Hinnerk Becker, Essen (DE); Michael Grass, Haltern am See (DE); Markus Winterberg, Datteln (DE); Dietrich Maschmeyer, Recklinghausen (DE); Christian Boeing, Koeln (DE)

(73) Assignee: Evonik Degussa GmbH, Essen (DE)

(21) Appl. No.: 14/119,994

(22) PCT Filed: Apr. 26, 2012
(86) PCT No.: PCT/EP2012/057639

§ 371 Date: Nov. 25, 2013

(30) Foreign Application Priority Data
Jun. 21, 2011 (DE) 10 2011 077 857.8

(51) Int. Cl. C08K 5/1535

(52) U.S. Cl. CPC C08K 5/1535
USPC 524/109; 549/464

(57) ABSTRACT

Dianhydrohexitol diesters of 2-ethylheptanoic acid

The present invention relates to dianhydrohexitol diesters of 2-ethylheptanoic acid. The present invention also relates to a mixture which comprises an ester of this type, and to the use of the ester and of the mixture.

Polyvinyl chloride (PVC) is one of the polymers of greatest commercial importance. It has a wide variety of applications not only in the form of rigid PVC but also in the form of flexible PVC.

A flexible PVC is produced by adding plasticizers to the PVC, and in most instances the materials used here are phthalic esters, in particular di-2-ethylhexyl phthalate (DEHP), diisononyl phthalate (DINP) and diisodecyl phthalate (DIDP). Examples of other materials also used alongside these as plasticizers for plastics such as polyvinyl chloride (PVC), polyvinyl butyral (PVB) and polyolefins are alicyclic polycarboxylic esters, for example the esters of cyclohexane-1,2-dicarboxylic acid, since these are considered to be safer than the corresponding phthalic esters in terms of health risk.

EP 2 114 952 A0 describes a mixture of dianhydrohexitol diesters comprising at least two different diesters which differ in the constitution of at least one of the carboxylic acid moieties present.

Starting from the known prior art, the object of the present invention consisted in providing a compound having precisely defined acid content which does not vary. The plasticizer properties of this compound were intended, in respect of selected physical parameters, to be better than or at least exactly as good as those of the mixture described in EP 2 114 952 A0.

A disadvantage of ester mixtures is often that these are imprecisely defined or can change their composition from one batch to the next.

A compound according to the formula I solves the problem:

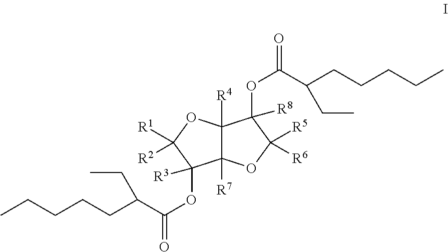

where R¹ to R⁸=H or alkyl group having from 1 to 6 carbon atoms, where the moieties R¹ to R⁸ can be identical or different.

In one embodiment of the invention, the moieties R¹ and R⁶, and also R² and R⁵, are respectively identical.

In one embodiment of the invention, the moieties R¹, R², R⁵ and R⁶ are respectively H.

In one embodiment of the invention, the moieties R⁴ and R⁷ are identical.

In one embodiment of the invention, the moieties R⁴ and R⁷ are respectively H.

In one embodiment of the invention, the moieties R¹ to R⁸ are respectively H.

In one embodiment of the invention, at least one of the moieties R¹ to R⁸ is not H.

In one embodiment of the invention, the compound has an inversion centre.

In one embodiment of the invention, the compound has no inversion centre.

The claims also include, alongside the compound itself, a mixture which comprises at least one of the compounds described above.

In one embodiment, the mixture comprises:
a compound as described above,
a polymer.

The polymer can by way of example have been selected from: polyvinyl chloride (PVC), polyvinyl butyral (PVB) and the polyalkyl methacrylates (PAMA).

In another embodiment, the ratio by mass of polymer to the compound of the formula I is from 30:1 to 1:2.5.

In another embodiment, the mixture also comprises:
a plasticizer which does not correspond to the formula I.

The plasticizer which does not correspond to the formula I can by way of example have been selected from the trialkyl citrates, acylated trialkyl citrates, glycerol esters, glycol dibenzoates, alkyl benzoates, dialkyl adipates, trialkyl trimellitates, dialkyl terephthalates, dialkyl phthalates or the dialkyl esters of 1,2-, 1,3- or 1,4-cyclohexanedicarboxylic acids, where the alkyl moieties have from 4 to 13, preferably 5, 6, 7, 8, 9, 10, 11, 12 or 13, carbon atoms. The plasticizers can also be dianhydrohexitol esters, preferably isosorbide diesters, of other carboxylic acids, for example n- or isobutyric acid, valeric acid or 2-ethylhexanoic acid.

In another embodiment, the molar ratio of the plasticizer which does not correspond to the formula I to the compound according to the formula I is from 1:10 to 10:1.

In preferred mixtures which comprise the compound according to the formula I and plasticizers which do not correspond to the formula I, the molar ratio of plasticizers to the compound according to formula I is preferably from 1:10 to 10:1, with preference from 1:6 to 6:1. The plasticizers preferably involve a plasticizer selected from: alkyl benzoates, dialkyl adipates, trialkyl citrates, acylated trialkyl citrates, trialkyl trimellitates, glycol dibenzoates, dialkyl terephthalates, dialkyl phthalates, dialkanoyl esters of isosorbide, or dialkyl esters of 1,2-, 1,3- or 1,4-cyclohexanedicarboxylic acids.

In another embodiment, the polymer is polyvinyl chloride (PVC).

In another embodiment, the mixture does not comprise any different diesters which differ in the constitution of at least one of the carboxylic acid moieties C₈H₁₇COO present.

The claims also include, alongside the mixture per se, use thereof as plasticizer.

In another embodiment, the mixtures according to the invention are used as plasticizers in plastisols, in adhesives or in components of adhesives, or in sealants. Particularly preferred plastisols here are PVC plastisols or PAMA plastisols.

Particularly preferred plastics here are polyvinyl chloride (PVC), polyvinyl butyral (PVB), homo- and copolymers based on ethylene, on propylene, on butadiene, on vinyl acetate, on cellulose acetate, on glycidyl acrylate, on glycidyl methacrylate, on methacrylates, on acrylates, on acrylates having, bonded at the oxygen atom of the ester group, alkyl moieties of branched or unbranched alcohols having from one to ten carbon atoms, on styrene, or on acrylonitrile, and homo- or copolymers of cyclic olefins.

In another embodiment, the mixtures according to the invention are used as solvents in plastics or in components of plastics.

The plastic here can by way of example have been selected from: polyacrylates having identical or different alkyl moieties having from 4 to 8 carbon atoms, bonded at the oxygen atom of the ester group, in particular having the n-butyl, n-hexyl, n-octyl or 2-ethylhexyl moiety, polymethacrylate, polymethyl methacrylate, methyl acrylate-butyl acrylate copolymers, methyl methacrylate-butyl methacrylate copolymers or generally polyalkyl methacrylates (PAMA), ethylene-vinyl acetate copolymers, chlorinated polyethylene, nitrile rubber, acrylonitrile-butadiene-styrene copolymers, ethylene-propylene copolymers, ethylene-propylene-diene copolymers, styrene-acrylonitrile copolymers, acrylonitrile-butadiene rubber, styrene-butadiene elastomers, methyl methacrylate-styrene-butadiene copolymers, cellulose acetate, PVB and PVC. A particularly preferred plastic here is PVC.

In another embodiment, the mixture according to the invention is used in paints, in inks or in coating materials.

In another embodiment, the mixture according to the invention is used as solvent, as component of lubricating oil, as coolant liquid, as drilling fluid or constituent thereof or as auxiliary in the processing of metal.

The mixtures according to the invention can moreover be used to modify plastics mixtures, for example the mixture of a polyolefin with a polyamide.

Compositions made of plastic(s), in particular PVC or PAMA, which comprise the mixtures according to the invention are found by way of example in the following products: casings for electrical devices, for example kitchen machines, computer casings, casings and components of audio and television equipment, pipes, apparatus, cables, wire sheathing, insulating tapes, in interior design, in vehicle construction and furniture construction, plastisols, in floor coverings, medical items, food packaging, gaskets, composite and other foils, audio disks, synthetic leather, toys, packaging containers, adhesive-tape foils, apparel, coatings, flocked products and printed products, fibres for fabrics, and coated fabrics. Compositions made of plastic, in particular PVC, which comprise mixtures according to the invention which comprise, or consist of, the esters of the formula I can moreover be used by way of example to produce the following products: pipes, hoses, cables, wire sheathing, insulating tapes, in vehicle construction and furniture construction, plastisols, profiles, floor coverings, medical items (e.g. blood bags, hoses, infusion bags, etc.), toys, food packaging, gaskets, composite and other foils, sheets, synthetic leather, wallpapers, packaging containers, adhesive-tape foils, apparel, coatings or fibres for fabrics, shoes, underbody protection, seam seals, roof sheeting, modelling materials or balls.

PVC compositions or plastisols which comprise PVC and a mixture according to the invention preferably comprise from 5 to 250 parts by mass, with preference from 10 to 200 parts by mass and with particular preference from 20 to 100 parts by mass, of the mixture according to the invention per 100 parts by mass of PVC.

The compound according to the invention can by way of example be obtained by esterifying 2-ethylheptanoic acid with isosorbide.

### EXAMPLE 1

### Production of Isosorbide di-2-ethylheptanoate (According to the Invention)

In a 2 litre multinecked flask with stirrer, water separator, dropping funnel, internal thermometer and immersion tube, 365 g (2.5 mol) of isosorbide (Roquette) were heated to boiling with 948 g (6.0 mol) of 2-ethylheptanoic acid and 2.19 g of H₃P0₂ (0.6% by mass, based on isosorbide), with stirring and with nitrogen bubbled into the mixture by way of the immersion tube (6 l/h). The temperature rose to 240° C. during the course of the reaction. Starting at 240° C., the temperature was held constant by adding cyclohexane and it was ensured that all of the water of reaction could be discharged by way of the water separator. The course of the reaction was followed by GC analysis. After a total of about 14.5 hours, the reaction had ended, and the water separator was then replaced by a distillation bridge by way of which it was possible to remove the excess 2-ethylheptanoic acid by distillation at a temperature up to 200° C. with a vacuum of <1 mbar. The vacuum was then adjusted to 40 mbar by bubbling nitrogen (at 200° C.) into the mixture. The product was purified in a stream of nitrogen for two hours at constant temperature. Nitrogen was then bubbled into the mixture while it was cooled to 80° C., and it was filtered by way of a suction funnel with filter paper and filter aid (D14 filter pearlite). The product was then neutralized at 80° C. with 2% of basic aluminium oxide (Sigma-Aldrich), based on the amount of ester. The Hazen/APHA colour value of the resultant compound was 12 and its acid number was 0.056 mg KOH/g. Purity determined by way of GC analysis was 98.9%.

The isosorbide diisononanoate not according to the invention used as comparative product in the following examples was produced by analogy with Example 1, but from isosorbide and isononanoic acid.

### EXAMPLE 2

### Production of Isosorbide Diisononanoate (Comparative Example)

In a 4 litre multinecked flask with stirrer, water separator, dropping funnel, internal thermometer and immersion tube, 803 g (5.5 mol) of isosorbide (Roquette) were heated to boiling with 2212 g (14 mol) of freshly distilled isononanoic acid (produced in accordance with WO2008/095571, Example 1) and 4.82 g of H₃PO₂ (0.6% by mass, based on isosorbide), with stirring and with nitrogen bubbled into the mixture by way of the immersion tube (6 l/h). The temperature rose to 240° C. during the course of the reaction. Starting at 240° C., the temperature was held constant by increasing the stream of nitrogen and it was ensured that all of the water of reaction could be discharged by way of the water separator. The course of the reaction was followed by GC analysis. After a total of about 9 hours, the reaction had ended. 1% of activated charcoal (CAP Super from Norit), based on input weight, was added to the reaction product, and the water separator was replaced by a distillation bridge by way of which the excess isononanoic acid was removed by distillation at a temperature of 215° C. and at a vacuum of <1 mbar. The vacuum was then adjusted to 40 mbar by bubbling nitrogen (at 200° C.) into the mixture. The product was purified in a stream of nitrogen for two hours at constant temperature. Nitrogen was then bubbled into the mixture while it was cooled to 80° C., and it was filtered by way of a suction funnel with filter paper and filter aid (D14 filter pearlite). The product was then neutralized at 80° C. with 2% of basic aluminium oxide (Sigma-Aldrich), based on the amount of ester. The Hazen/APHA colour value of the resultant compound was 13 and its acid number was 0.054 mg KOH/g. Purity determined by way of GC analysis was 99.8%.

The product according to the invention and the comparative product were then tested for their suitability as plasticizer in PVC formulations.

Example of Production of Plastisols

The input weights of the components used for the various plastisols can be found in Table 1 below.

TABLE 1
Plastisol formulation (all data in phr (=parts by mass per 100 parts by mass of PVC))

| | Formulation 1 (according | Formulation 2 |
|---|---|---|
| Formulation: | to the invention) | (comparative compound) |
| B 7021 Ultra | 100 | 100 |
| Isosorbide diisononanoate | 50 | |
| Isosorbide di-2-ethylheptanoate | | 50 |
| Drapex 39 (epoxidized soya bean oil, | 3 | 3 |
| Galata) | | |
| Mark CZ 149 (Ca—Zn stabilizer, | 2 | 2 |
| Galata | | |

For both esters here, R¹ to R⁸ are H.

The plasticizers were conditioned to 25° C. prior to addition. The constituents were weighed into a PE beaker in the following order: first the liquid constituents and then the pulverulent constituents. The mixture was mixed manually with a paste spatula until no unwetted powder remained. The mixing beaker was then clamped into the clamping apparatus of a dissolver mixer. Prior to immersion of the stirrer into the mixture, the rotation rate was set to 1800 revolutions per minute. Once the stirrer had been switched on, stirring was continued until the temperature on the digital display of the thermoindicator reached 30.0° C. This ensured that homogenization of the plastisol was achieved with defined energy input. The plastisol was then immediately conditioned at 25.0° C.

Measurement of Plastisol Viscosities

The viscosities of the plastisols produced as described above were measured as follows by a method based on DIN 53 019, using a Physica DSR 4000 rheometer (Paar-Physica), which is controlled by the associated US 200 software:

The plastisol was again stirred with a spatula in the feed vessel and was tested in accordance with the operating instructions in test system Z3 (DIN 25 mm). The measurement proceeded automatically at 25° C. by way of the abovementioned software. The settings were as follows:
Pre-shear at 100 s⁻¹ for a period of 60 s, during which no values were measured
A downward progression beginning at 200 s⁻¹ and ending at 0.1 s⁻¹, divided into a logarithmic series with 30 steps, the duration of each point of measurement being 5 s.

After the test, the test data were processed automatically by the software. Viscosity was plotted as a function of shear rate. Between the tests, the paste was stored at 25° C.

Table 2 below lists respectively the viscosity of the PVC paste based on the isosorbide di-2-ethylheptanoate (1) according to the invention and, as Comparative Example, based on an isosorbide diisononanoate (2) not according to the invention, as a function of shear rate in 100 s⁻¹.

TABLE 2
Viscosities of (1) and (2) respectively in Pa*s:

| Shear rate [100 s⁻¹] | (1) | (2) |
|---|---|---|
| 8.61 | 5.17 | 5.24 |
| 6.63 | 4.58 | 4.7 |
| 5.1 | 4.11 | 4.27 |
| 3.92 | 3.75 | 3.95 |
| 3.02 | 3.48 | 3.71 |
| 2.32 | 3.28 | 3.54 |
| 1.79 | 3.14 | 3.43 |
| 1.37 | 3.05 | 3.36 |
| 1.06 | 2.99 | 3.32 |
| 0.814 | 2.97 | 3.31 |
| 0.626 | 2.95 | 3.34 |
| 0.482 | 2.98 | 3.37 |
| 0.371 | 3.01 | 3.44 |
| 0.285 | 3.06 | 3.54 |
| 0.22 | 3.14 | 3.65 |
| 0.169 | 3.24 | 3.77 |
| 0.13 | 3.37 | 3.91 |
| 0.1 | 3.5 | 4.07 |

Surprisingly, it was found that when the PVC pastes based on the isosorbide ester of 2-ethyl-heptanoic acid (1) according to the invention are compared with the analogous paste based on the isosorbide ester of isononanoic acid (2) (corresponding to EP 2 114 952 A0) not according to the invention, the former exhibit lower viscosity and thus improved processibility over the entire shear range tested. The esters according to the invention therefore have better plasticizer properties than the comparative ester, which corresponds to an ester as described in EP 2 114 952 A0.

Measurement of Thermal Stability

The thermal stability tests were carried out in a Mathis Thermotester (LTE-TS, Mathis AG). The specimen frame for the thermal stability test has 14 aluminium profiles. The aluminium profiles serve as specimen holders in which specimens up to a maximum width of 2 cm are placed. A guillotine was used to remove the edges of the foils to be tested, and the foils were cut to give rectangles (dimensions: 20 cm×30 cm). Two strips (20*2 cm) were then cut from the material. The strips were placed alongside one another in the aluminium profiles of the frame for the thermal stability test, and secured by the metal clamp. The 3 outermost profiles in the frame were not used, since the temperature is most uniform in the centre of the Mathis oven.

The parameters set on the Mathis Thermotester were as follows:

Temperature: 200° C.

Interval advance: 28 mm

Time interval: 1 min

Ventilator rotation rate: 1800 rpm

Once the temperature had been regulated, the frame was engaged with the transport system of the Thermotester and the test was begun. Byk colour-measurement equipment (Spectro Guide 45/0, Byk Gardner) was used to determine the L* a* b* values, inclusive of the yellowness index Yi, of the cooled test strips, in accordance with the D1925 index. The best possible test results were achieved by using illuminant C/2° and a specimen observer. The thermal stability strips were then measured at each advance (28 mm). The thermal stability strips are composed of two 20 cm strips, and no measured value was therefore determined at the point of intersection. The measured values were determined directly on the sample card with reference to a white tile.

Table 3 below lists respectively the yellowness indices Yi for the thermal stabilities for a PVC paste based on the isosorbide di-2-ethylheptanoate (1) and, as Comparative Example, one based on an isosorbide diisononanoate (2) not according to the invention, as a function of residence time in minutes.

TABLE 3
Yellowness index Yi of (1) and (2)

| Residence time [min] | (1) | (2) |
|---|---|---|
| 1 | 1.90 | 2.08 |
| 2 | 2.92 | 2.23 |
| 3 | 3.41 | 3.29 |
| 4 | 4.11 | 4.60 |
| 5 | 4.54 | 7.05 |
| 6 | 5.07 | 12.06 |
| 8 | 9.85 | 36.24 |
| 9 | 18.05 | 54.56 |
| 10 | 33.72 | 72.73 |
| 11 | 57.88 | 90.82 |
| 12 | 85.39 | 139.49 |

Surprisingly, it was found that when the PVC pastes based on the isosorbide ester of 2-ethyl-heptanoic acid (1) according to the invention are compared with the analogous paste based on the isosorbide ester of isononanoic acid (2) (corresponding to EP 2 114 952 A0) the former exhibit better thermal stability. The esters according to the invention therefore have better plasticizer properties than the comparative ester, which corresponds to an ester as described in EP 2 114 952 A0.

On the basis of the test values for viscosity and for Yellowness index, it has been shown that the compound according to the invention, or a mixture which comprises such a compound, exhibits better plasticizer properties than the comparative compound in respect of selected physical parameters.

1. A compound of formula 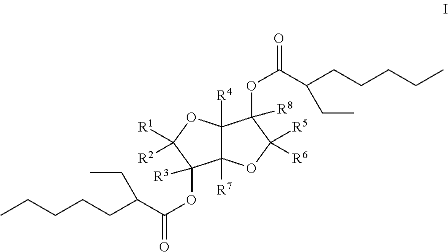
wherein R¹, R², R³, R⁴, R⁵, R⁶, R⁷, and R⁸ are each independently H or an alkyl group having from 1 to 6 carbon atoms, in which moieties R¹, R², R³, R⁴, R⁵, R⁶, R⁷, and R⁸ can be identical or different.

2. The compound according to claim 1, wherein the moieties R¹ and R⁶ are identical, and R² and R⁵ are respectively identical.

3. The compound according to claim 1, wherein the moieties R¹, R², R⁵ and R⁶ are respectively H.

4. The compound according to claim 1, wherein the moieties R⁴ and R⁷ are identical.

5. The compound according to claim 1, wherein the moieties R⁴ and R⁷ are respectively H.

6. The compound according to claim 1, wherein the moieties R¹, R², R³, R⁴, R⁵, R⁶, R⁷, and R⁸ are respectively H.

7. The compound according to claim 1, wherein at least one of the moieties R¹, R², R³, R⁴, R⁵, R⁶, R⁷, and R⁸ are not H.

8. The compound according to claim 1, wherein the compound has an inversion centre.

9. The compound according to claim 1, wherein the compound has no inversion centre.

10. A mixture comprising:
the compound of formula I according to claims 1, and
a polymer.

11. The mixture according to claim 10, wherein a ratio by mass of the polymer to the compound of formula I is from 30:1 to 1:2.5.

12. The mixture according to claim 10, further comprising a plasticizer which does not correspond to formula I.

13. The mixture according to claim 12, wherein a molar ratio of the plasticizer to the compound of formula I is from 1:10 to 10:1.

14. The mixture according to claim 10, wherein the polymer is polyvinyl chloride.

15. The mixture according to claim 10, wherein the mixture does not comprise any different diesters which differ in constitution of a carboxylic acid moiety C₈H₁₇COO present.

16. The compound according to as claim 1, wherein the compound is a plasticizer.
